(19) United States
(12) Patent Application Publication
(10) Pub. No.: US 2016/0278538 A1
(43) Pub. Date: Sep. 29, 2016

(54) MATTRESS

(71) Applicants: Charbel NASSIF, Saint-Eustache (CA); Layal BARAKAT, Saint-Eustache (CA)

(72) Inventors: Charbel NASSIF, Saint-Eustache (CA); Layal BARAKAT, Saint-Eustache (CA)

(21) Appl. No.: 15/079,689

(22) Filed: Mar. 24, 2016

Related U.S. Application Data
(60) Provisional application No. 62/138,014, filed on Mar. 25, 2015.

(51) Int. Cl. A47D 15/00; B68G 7/00; A47C 27/14

(52) U.S. Cl. CPC A47D 15/001; A47C 27/148; B68G 7/00

(57) ABSTRACT

A mattress including a plurality of resting zones. At least two of the resting zones are disposed on a first side of the mattress, and at least another one of the resting zones is disposed on an opposed second side of the mattress. Each resting zone has an exposed resting surface occupying at least a portion of a surface of the first or second side. Each resting zone extends into the mattress from the resting surface to define a zone layer, the zone layer of each resting zone having a firmness. The firmness of the zone layer for each resting zone is different from the firmness of the zone layer for each of the other resting zones. The firmness of each resting zone is associated with an age of a user of the mattress.

### CROSS-REFERENCE TO RELATED APPLICATIONS

The application claims priority to U.S. provisional patent application 62/138,014 filed Mar. 25, 2015, the entire contents of which are incorporated by reference herein.

### TECHNICAL FIELD

The application relates generally to bedding and, more particularly, to a mattress.

### BACKGROUND

As infants age, their bedding needs change rapidly. For example, newborn babies are relatively tiny bundles, and can sleep on relatively tiny mattresses. As babies grow, however, they require a larger mattress, and one that is more suited to their stronger bodies. Mattresses that are specifically designed/suited to infants are thus used.

Some conventional infant mattresses are known as “2-in-1” mattresses because one side of the mattress is intended for newborns, while the other side of the mattress is intended for older infants and toddlers. However, parents often find it difficult to determine which side of the mattress is intended for their child given her or his specific age. Furthermore, the age range for each side of the mattress is often indicated on the packaging for the mattress, which can be lost or forgotten by the parent once the mattress has been used for many months or years. Furthermore, some conventional 2-in-1 mattresses are intended to cover a broad range of ages, and may thus not be suited for children of a specific age.

### SUMMARY

In one aspect, there is provided a mattress, comprising: a plurality of resting zones, at least two of the resting zones being disposed on a first side of the mattress and at least another one of the resting zones being disposed on an opposed second side of the mattress, each resting zone having an exposed resting surface occupying at least a portion of a surface of the first or second side, each resting zone extending into the mattress from the resting surface to define a zone layer, the zone layer of each resting zone having a firmness, the firmness of the zone layer for each resting zone being different from the firmness of the zone layer for each of the other resting zones, the firmness of each resting zone being associated with an age of a user of the mattress.

In another aspect, there is provided a method of making a mattress, comprising: forming resting zones on a first side and an opposed second side of the mattress, at least two resting zones being on the first side, and at least one resting zone being on the second side; providing a different firmness to each resting zone; and associating the firmness of each resting zone to an age of a user of the mattress.

In a further aspect, there is provided an infant mattress, comprising: a plurality of resting zones, at least two of the resting zones being disposed on a first side of the mattress and at least another one of the resting zones being disposed on an opposed second side of the mattress, each resting zone having an exposed resting surface occupying at least a portion of a surface of the first or second side, each resting zone extending into the mattress from the resting surface to define a zone layer, the zone layer of each resting zone having a firmness, the firmness of the zone layer for each resting zone being different from the firmness of the zone layer for each of the other resting zones; and bedding mountable to the mattress to cover at least one of the first and second sides and the resting zones thereon, the bedding having age indicators permanently affixed thereto and being indicative of an age of a user of the mattress, each age indicator being associated with a corresponding resting zone.

### DESCRIPTION OF THE DRAWINGS

Reference is now made to the accompanying figures in which:

FIG. 1A is a perspective view of a first side of a mattress, according to an embodiment of the present disclosure;

FIG. 1B is a perspective view of a second side of the mattress of FIG. 1A;

FIG. 2 is a perspective cross-sectional view of the mattress of FIG. 1A, taken along the line II-II;

FIG. 3A is a perspective view of a first side of a mattress having bedding applied thereon, according to another embodiment of the present disclosure;

FIG. 3B is a perspective view of a second side of the mattress of FIG. 3A; and

FIG. 4 is a perspective view of a mattress with bedding having a closeable flap and an inclined insert, according to yet another embodiment of the present disclosure.

### DETAILED DESCRIPTION

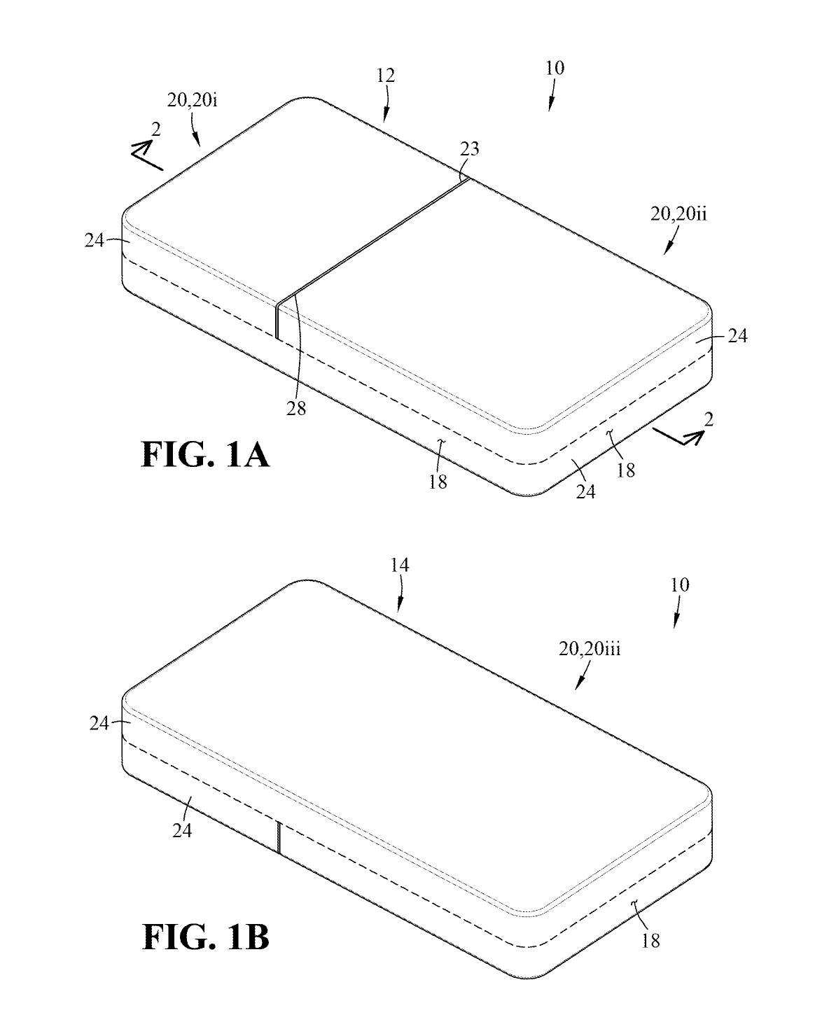

FIGS. 1A and 1B illustrate a mattress 10 of a type preferably provided for use with babies, infants, and young children. As will be described in greater detail herein, the mattress 10 provides a suitable resting support for children of various ages, and helps parents at all times to locate the zone of the mattress that is best suited for the age of their child. The mattress 10 has a first side 12 representing one side of the mattress 10 for receiving a child thereon, and an opposed second side 14 representing the other side of the mattress 10 for receiving the child.

The mattress 10 includes a plurality (e.g. at least three) of distinct resting zones 20, distributed on the sides 12,14 of the mattress 10. More particularly, the mattress 10 has two or more resting zones 20 on, or associated with, the first side 12, and one or more resting zones 20 on, or associated with, the second side 14. Each resting zone 20 provides an appropriate platform for supporting a sleeping or resting child of a given age group. As will be explained, each resting zone 20 has a material property which is different from that of the other resting zones 20. Such material properties can include, but are not limited to, firmness, surface texture, breathability, impermeability, surface pattern, surface colour, etc.

When the child has outgrown the parameters of one resting zone 20, or wishes to transition to a different resting zone 20 corresponding to a different age or age group, the child is able to easily do so because the age groups of the different resting zones are easily visualized, as explained in greater detail below. Each resting zone 20 has an exposed resting surface 22, a zone layer 24, and a firmness, all of which are now discussed in greater detail.

Each resting surface 22 is exposed to view such that it can be visually observed. Each resting surface 22 occupies or spans some or all of the surface area of the side 12,14 of the mattress 10 on which it is located. Each resting surface 22 therefore defines the boundaries or limits of each resting zone 20 in the planes defined by the first and second sides 12,14. These limits may be indicated with an appropriate boundary marker 23, which delimits the boundary of adjacent resting zones 20 on the same side 12,14 of the mattress 10. The boundary marker 23 therefore indicates where one resting surface 22 ends and where another resting surface 22 begins. In the embodiment shown, the resting surfaces 22 of adjacent resting zones 20 on the same side of the mattress are separated by a physical feature. In the embodiment shown, the physical feature is a groove or gap 28 between the materials of each resting zone 20.

Still referring to FIGS. 1A and 1B, each zone layer 24 defines the depth of each resting zone 20 from the corresponding first or second side 12,14, and from the corresponding resting surface 22. Each zone layer 24 therefore defines the thickness of each resting zone 20, which is measured between the resting surface 22 on the first or second side 12,14, and the depth of the zone layer 24 within the body of the mattress 10. Each zone layer 24 can be made of one single material, such as a layer of foam, or from multiple different materials. The material or materials of each zone layer 24 are largely determinative of the firmness of the zone layer 24, and thus, of the resting zone 20. The firmness of each zone layer 24 is different from the firmness of every other zone layer 24. Therefore, each resting zone 20 has a different firmness from the other resting zones 20.

The term “firmness” used herein refers to the response to deflection by each resting zone 20 upon the child applying weight to, or resting on, said resting zone 20, as experienced by the child. Firmness is largely determined by touch or feel, and is a somewhat subjective parameter because some users may characterise the response as firm, while others may not. Irrespective of its subjective nature, users are able to differentiate between materials having different firmness. Therefore, a user of the mattress 10 would be able to determine if the zone layer 24 of one resting zone 20 is more or less firm than the zone layer 24 of another resting zone 20.

Some industry standards are used to measure the firmness of a mattress 10. For example, the firmness of the mattress 10 can be associated with the density of the material used in the resting zones 20. A resting zone 20 having a high density may be more firm than a resting zone 20 having a lower density. Another such standard is the Impression Load Deflection, or ILD. This parameter is also known as Impression Force Deflection, or IFD. ILD and IFD are measured by pressing a 12-inch round disk into a 4-inch thick piece of foam until the round disk presses 25% (or 1 inch) into the foam. The amount of weight or pressure required to compress the mattress to that extent is the ILD or IFD. Generally, the higher the ILD value, the more firm the zone layer 24 is. Some ILD values for the zone layers 24 range from about 15 to about 55 lbs., depending on the foam being used. Of course, the ILD values may be different if a material other than polyurethane foam is used for each resting zone 20. Indeed, each zone layer 24 can be made of one or more materials (foam, rubber, coil springs, etc.), and the material make up of each zone layer 24 can differ.

In the embodiment shown in FIGS. 1A and 1B, the mattress 10 has first, second, and third resting zones 20i,20ii,20iii. The first and second resting zones 20i,20ii are disposed on the first side 12 of the mattress 10. The length and area occupied by each resting zone 20i,20ii on the first side 12 can vary. For example, the first resting zone 20i is intended to receive thereon a newborn, and can therefore occupy less of the length of the first side 12 (and thus less of its surface area) than the second resting zone 20ii, which is intended to receive larger and older babies. Of course, other divisions of the surface area of the first side 12 are also within the scope of the present disclosure. The third resting zone 20iii is disposed on the opposed, second side 14 of the mattress 10. Since the third resting zone 20iii is the only resting zone on the second side 14 of the mattress 10 in this embodiment, its resting surface 22 occupies the entire surface area of the second side 14.

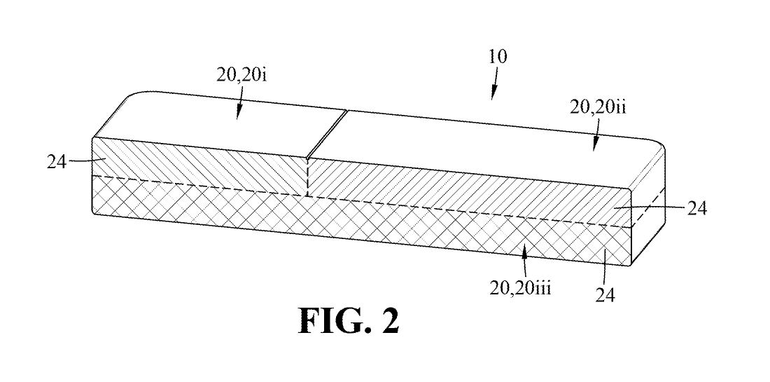

FIG. 2 is a cross-sectional view of a mattress 10 showing various zone layers 24. As can be seen, each of the zone layers 24 has a different material composition (e.g. different density, resiliency, etc.). For example, each of the zone layers 24 can have a different layer of foam, each layer of foam providing a different firmness. Of course, and as explained above, the zone layers 24 can have similar material compositions as well.

The firmness of each of the zone layers 24 of the resting zones 20i,20ii,20ii varies. In the embodiment shown, the first resting zone 20i has the firmest zone layer 24, and thus its firmness is greater than that of both zone layers 24 of the second and third resting zones 20ii,20iii. The second resting zone 20ii has the second firmest zone layer 24, and thus its firmness is greater than that of the zone layer 24 of the third resting zone 20iii, but less than that of the first resting zone 20i. This configuration of firmness is appropriate for newborns and young children. More particularly, the first resting zone 20i is the firmest of them all, which is suitable because it is intended to receive thereon a newborn aged 0 to 6 months. Similarly, the second resting zone 20ii is less firm than the first resting zone 20i but more firm than the third resting zone 20iii, which is suitable because it is intended to receive thereon a baby aged 6 to 12 months. Finally, the third resting zone 20iii is the least firm because it is intended to receive thereon a toddler of 12 months or more who requires less support than a newborn or baby.

It can thus be appreciated that each resting zone 20 has an age associated therewith. More particularly, the firmness of each resting zone 20 is associated with an age of a user of that resting zone 20, and thus, of a user of the mattress 10. Stated differently, the firmness of each resting zone 20 may be selected based on the age of the user who will be resting thereon.

Various devices and techniques may be used to help a person identify which resting zone 20 is appropriate for a particular user. Some of these are now discussed.

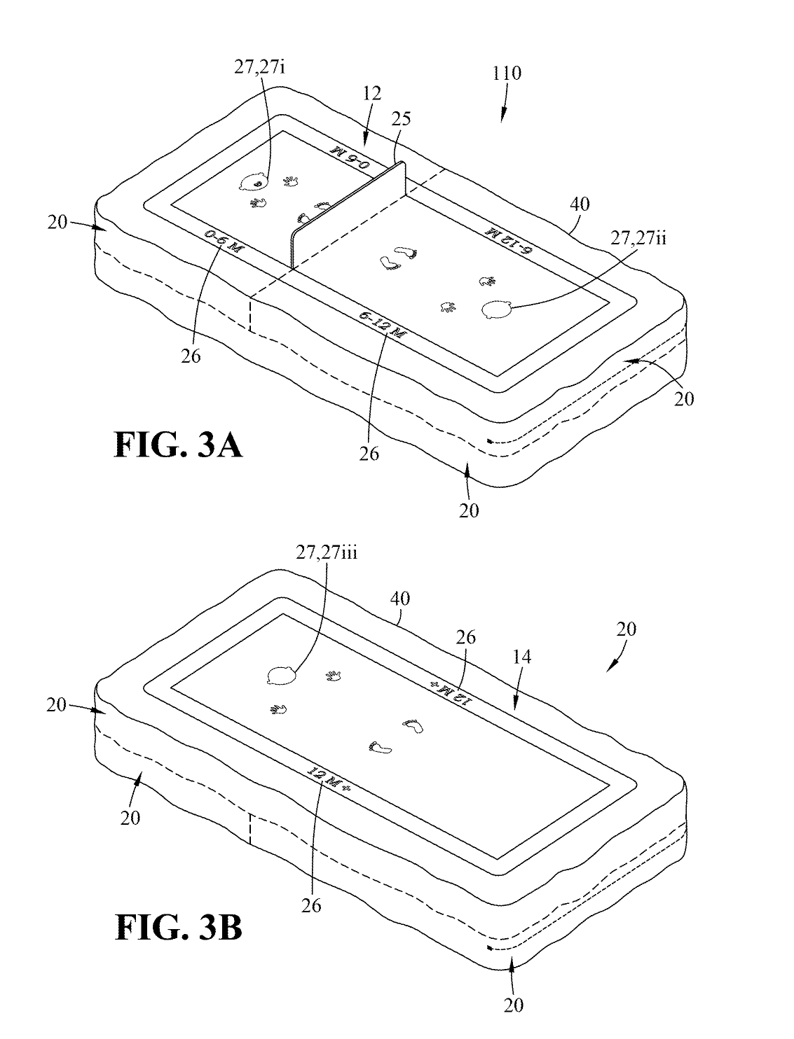

FIGS. 3A and 3B show an embodiment of the mattress 110 having bedding 40. The bedding 40 may include any suitable fabric, cloth, or object which can be mounted to the mattress 110 to cover the first and/or second sides 12,14, and removed from the mattress 110. The bedding 40 may therefore be any suitable mattress cover, blanket, sheet, or bedspread, etc. The bedding 40 has one or more numerical age indicators 26 which are permanently affixed to the bedding 40. Each bedding age indicator 26 is visible and indicative of an age of the user of the mattress, and corresponds to the age associated with the firmness of the resting zone covered by the bedding 40. The parent of an infant who uses the mattress 110, for example, will therefore be able to quickly match the age indicators 26 of the bedding 40 with the ages associated with the resting zones when dressing the mattress 110. The bedding 40 may also have an image 27 which is displayed on an exposed surface of the bedding 40, and which is indicative of the age of the user. In the embodiment shown, each image 27 is a non-numeric stylized caricature of an infant at various stages in her development.

If so desired, the bedding 40 may include a barrier 25, which can be connected to or removed from the bedding 40 in order to maintain the child within the confines of one resting surface. The barrier 25 therefore limits, and may also prevent, the movement of the child between adjacent resting zones of the same side 12,14.

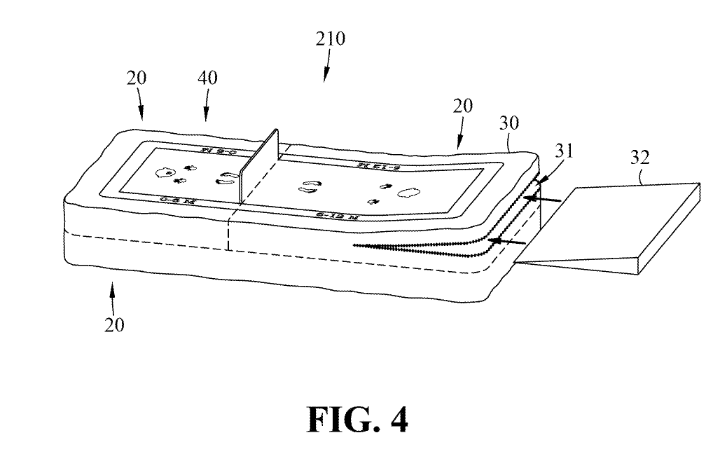

Each age indicator 26 indicates to its observer the age, or range of ages, of children that are intended to rest in that particular resting zone. It can thus be appreciated that the age indicator 26 can take many configurations to achieve such functionality, all of which are within the scope of the present disclosure. For example, and as shown in FIGS. 3A and 3B, the age indictor 26 can include a numerical display, print or other suitable marking of the age or age group placed directly on the bedding 40. In FIG. 3A, some of the age indicators 26 on the first side 12 of the mattress 110 include the marking “0-6 M”, which informs the viewer of those age indicators 26 that the associated resting zone is intended to receive children aged zero to six months. Similarly, in FIG. 4B, the age indicators 26 on the second side 14 include a marking of “12M+”, which inform the viewer that the associated resting zone is intended to receive children aged twelve months or more. Other types of age indicators 26 may also be used. For example, the age indicator 26 may include a tag or label, affixed to the corresponding resting zones, which provide the age or age group of its resting zone. The age indicator 26 can also be disposed on other parts of the mattress 110 that are easily visible, such as one of the side walls. It can thus be appreciated that the age indicator 26 can be any object which indicates the age or age group of its resting zone 20, and which can be permanently affixed to the mattress 110 or difficultly removed therefrom.

The mattress 110 may also have other visual indicia of the age of the user. For example, and as shown in FIGS. 3A and 3B, the mattress 110 has an image 27 which is displayed on an exposed surface of the bedding 40, and which is indicative of the age of the user. In the embodiment shown, each image 27 is a non-numeric stylized caricature of an infant at various stages in her development, which is printed directly on the resting surfaces 22. For example, the image 27i on the bedding 40 covering one of the resting zones of the first side 12 where the age indicator 26 includes the marking “0-6 M” shows a baby's face, hands, and feet. The baby's face has a pacifier in its mouth, indicating that a relatively young baby (i.e. 0-6 months) should be placed on that resting zone 20. Similarly, the image 27ii for the the adjacent resting zone 20 of the first side 12 where the age indicator 26 includes the marking “6-12 M” shows a baby's face, hands, and feet. The baby's face this time does not have a pacifier in its mouth, and thus contrasts with the image 27i of the adjacent resting zone 20. The image 27ii of this resting zone 20 indicates that a relatively older baby (i.e. 6-12 months) should be placed on this resting zone 20. Similarly, and referring to FIG. 4B, the image 27iii in the resting zone 20 of the second side 14 where the age indicator 26 includes the marking “12 M+” shows an infant's face, hands, and feet. The face, hands, and feet, are larger than those of the images 27i,27ii on the first side 12 o the mattress 110. The image 27iii of this resting zone 20 indicates that a toddler (i.e. 12 months or greater in age) should be placed on this resting zone 20.

The age indicator 26 and/or image 27 therefore provides a simple, foolproof technique for knowing the age or age group of a particular resting zone 20 of the mattress 110. Consider for example the mattress 110 shown in FIGS. 4A and 4B. A parent is able to quickly visualize the age indicators 26 and/or images 27 and be able to determine which resting zone 20 of the mattress 110 is appropriate for their child.

This contrasts with some conventional children mattresses, such as 2-in-1 mattresses, which often do not indicate on the mattress itself which side is appropriate for which age or age group of children. Therefore, when a parent is using the mattress, she or he will be unable to visually confirm which side of the mattress is appropriate for their child. They will thus need to consult the original packaging for the mattress, which may be difficult because it may already have been discarded.

FIG. 4 shows another embodiment of the mattress 210. The bedding 40 of the mattress 210 includes a closeable flap 30 which extends along at least one side wall of the bedding 40. The opening and closing of the flap 30 can be achieved with any suitable device, such as a slide fastener (e.g. Zipper™) extending along a perimeter, a hook-and-loop fastener, buttons, etc. When opened, the flap 30 creates an opening 31 which can be manipulated to receive objects therein. One such object is an insert 32, which can be inserted through the opening 31. The insert 32 may be wedge-shaped or have an inclined surface, such that when inserted, the insert 32 causes the flap 30 to incline, such that the surface of bedding 40 over a corresponding resting zone is inclined at an angle relative to a horizontal plane. This creates an inclined resting surface, which may be suitable for children of a certain age or age group, such as newborns (0-6 months). The insert 32 can also add to the firmness of the resting zone, if additional firmness is desired, and therefore the firmness of the resting zone can be varied or modified as desired by introducing therein the insert 32.

In light of the preceding, it can be appreciated that the mattress 10 and its embodiments disclosed herein provides a “3-in-1”, “4-in-1”, “5-in-1”, etc. mattress 10 in which the firmness of different portions of the mattress 10 is associated with a particular age of the infant or person lying on said portion. Furthermore, the association of each firmness level with a portion of the mattress 10 is easily determined by a parent or user of the mattress 10. This is contrast to other conventional mattresses, such as “2-in-1” mattresses, which do not associate the age of users of the mattress to a particular firmness. These conventional mattresses, which are merely 2-in-1, are thus not directed toward specific developmental stages in the life of a child.

The mattress 10 thus promotes safe sleeping habits and surfaces for young infants, such as newborns, babies, and toddlers.

It will be appreciated that the terms “first” and “second” used to describe the sides 12,14 of the mattress 10 are interchangeable. More particularly, any feature disclosed herein as being associated with one of the sides 12,14 of the mattress 10 can just as easily be associated with the other side 14,12 of the mattress 10.

The above description is meant to be exemplary only, and one skilled in the art will recognize that changes may be made to the embodiments described without departing from the scope of the invention disclosed. For example, the mattress disclosed herein is described as being used with babies and children, but it will be appreciated that it can be used with human and non-human animals of any age. Still other modifications which fall within the scope of the present invention will be apparent to those skilled in the art, in light of a review of this disclosure, and such modifications are intended to fall within the appended claims.

1. A mattress, comprising: a plurality of resting zones, at least two of the resting zones being disposed on a first side of the mattress and at least another one of the resting zones being disposed on an opposed second side of the mattress, each resting zone having an exposed resting surface occupying at least a portion of a surface of the first or second side, each resting zone extending into the mattress from the resting surface to define a zone layer, the zone layer of each resting zone having a firmness, the firmness of the zone layer for each resting zone being different from the firmness of the zone layer for each of the other resting zones, the firmness of each resting zone being associated with an age of a user of the mattress.

2. The mattress of claim 1, further comprising bedding mountable to the mattress to cover at least one of the first and second sides and the resting zones thereon, the bedding having a plurality of age indicators being permanently affixed thereto, each age indicator corresponding to the age of the user associated with the firmness of said resting zone covered by the bedding.

3. The mattress of claim 1, wherein first and second resting zones are disposed on the first side of the mattress, the age associated with the first resting zone being between 0 and 6 months, the age associated with the second resting zone being between 6 and 12 months.

4. The mattress of any one of claims 1, wherein a third resting zone is disposed on the second side of the mattress, the resting surface of the third resting zone occupying all of the surface of the second side, the age associated with the third resting zone being 12 months and greater.

5. The mattress of claim 3, wherein the resting surface of the second resting zone occupies a greater portion of the surface of the first side than the resting surface of the first resting zone.

6. The mattress of claim 1, wherein first and second resting zones are disposed on the first side of the mattress, the firmness of the zone layer of the first resting zone being greater than the firmness of the zone layer of the second resting zone.

7. The mattress of claim 6, wherein a third resting zone is disposed on the second side of the mattress, the firmness of the zone layer of the second resting zone being greater than the firmness of the zone layer of the third resting zone.

8. The mattress of claim 7, wherein the age associated with the first resting zone is between 0 and 6 months, the age associated with the second resting zone is between 6 and 12 months, and the age associated with the third resting zone is 12 months and greater.

9. The mattress of claim 2, wherein the bedding includes a closeable flap along at least one side wall of the bedding, the flap being manipulable between an open position to define an opening and a closed position, the mattress further comprising an inclined insert insertable through the opening to incline the bedding covering a given resting zone relative to a horizontal plane.

10. The mattress of any claim 2, wherein the bedding has an image displayed on an exposed surface thereof, the image being indicative of the age of the user of the mattress.

11. A method of making a mattress, comprising:
forming resting zones on a first side and an opposed second side of the mattress, at least two resting zones being on the first side, and at least one resting zone being on the second side;
providing a different firmness to each resting zone; and
associating the firmness of each resting zone to an age of a user of the mattress.

12. The method of claim 11, wherein forming the resting zones includes forming first and second resting zones on the first side of the mattress, the age of the first resting zone being between 0 and 6 months, the age of the second resting zone being between 6 and 12 months.

13. The method of claim 12, wherein forming the resting zones includes forming a third resting zone on the second side of the mattress, the age of the third resting zone being 12 months and greater.

14. The method of claim 13, wherein providing the different firmness includes providing the firmness of the first resting zone to be greater than the firmness of the second resting zone.

15. The method of claim 14, wherein providing the different firmness includes providing the firmness of the second resting zone to be greater than the firmness of the third resting zone.

16. An infant mattress, comprising:
a plurality of resting zones, at least two of the resting zones being disposed on a first side of the mattress and at least another one of the resting zones being disposed on an opposed second side of the mattress, each resting zone having an exposed resting surface occupying at least a portion of a surface of the first or second side, each resting zone extending into the mattress from the resting surface to define a zone layer, the zone layer of each resting zone having a firmness, the firmness of the zone layer for each resting zone being different from the firmness of the zone layer for each of the other resting zones; and
bedding mountable to the mattress to cover at least one of the first and second sides and the resting zones thereon, the bedding having age indicators permanently affixed thereto and being indicative of an age of a user of the mattress, each age indicator being associated with a corresponding resting zone.

17. The infant mattress of claim 16, wherein first and second resting zones are disposed on the first side of the mattress, the age indicator being associated with the first resting zone indicating an age of between 0 and 6 months, the age indicator associated with the second resting zone indicating an age of between 6 and 12 months.

18. The infant mattress of claim 16, wherein a third resting zone is disposed on the second side of the mattress, the resting surface of the third resting zone occupying all of the surface of the second side, the age indicator associated with the third resting zone indicating an age of 12 months and greater.

19. The infant mattress of claim 18, wherein first and second resting zones are disposed on the first side of the mattress, the firmness of the zone layer of the first resting zone being greater than the firmness of the zone layer of the second resting zone.

20. The infant mattress of claim 19, wherein the age indicator associated with the first resting zone indicates an age of between 0 and 6 months, the age indicator associated with the second resting zone indicates an age between 6 and 12 months, and the age indicator associated with the third resting zone indicates an age of 12 months and greater.
